(19) United States
(12) Patent Application Publication
(10) Pub. No.: US 2024/0392450 A1
(43) Pub. Date: Nov. 28, 2024

(54) SYSTEM AND METHOD FOR MAKING GREEN HYDROGEN

(71) Applicants: Richard CHRYSLER, Davie, FL (US); Marlon EKHOFF, Grant Park, IL (US)

(72) Inventors: Richard CHRYSLER, Davie, FL (US); Marlon EKHOFF, Grant Park, IL (US)

(21) Appl. No.: 18/202,150

(22) Filed: May 25, 2023

(51) Int. Cl. C25B 1/50; C25B 1/04; C25B 9/015; C25B 15/08

(52) U.S. Cl. CPC C25B 1/50; C25B 1/04; C25B 9/015; C25B 15/085; C02F 1/441

(57) ABSTRACT

A system and method of making hydrogen from water. A cylindrical reaction vessel is provided with an outer shell, a central shaft, and one or more concentric inner tubes separated by annular spaces. Water is delivered to the annular spaces by a water pump through an inlet defined in the reaction vessel. The water courses along a tortuous flow path. That path begins at an inner annular space around a central shaft. It ends at an outer annular space. The water emerges from the reaction vessel through an outlet associated with a manifold. A high-frequency vibratory stimulus is applied to the reaction vessel and water. Water molecules are dissociated into hydrogen molecules and oxygen atoms. These reaction products are delivered through the manifold along an effluent flow path to a receiving pressure vessel before deployment to a sub-assembly for harnessing clean energy.

### TECHNICAL FIELD

This disclosure lies in the field of making hydrogen gas from an aqueous solution that is subjected to electrical energy and a vibrational disturbance.

### BACKGROUND

The quest for low carbon emissions has made hydrogen an attractive source of energy because it is found in large quantities, mainly in the form of water. When used as a fuel, hydrogen produces water vapor, making it a clean energy source. Hydrogen gas can be used as a fuel for fuel cell electric vehicles or combustion engines in hydrogen-powered vehicles.

Hydrogen fuel cells are efficient. They can convert up to 60% of the energy in the fuel into electricity. This compares to internal combustion engines, which are about 20% efficient. It is known that in combination with suitable auxiliary equipment, hydrogen can power various machines, heat buildings and generate electricity.

Hydrogen can be produced from renewable sources such as solar, wind, and hydropower. When produced this way, it can be considered a renewable energy source. But the sun does not always shine, and the wind may not blow as desired.

Overall, hydrogen has the potential to be a key component in a sustainable energy future, as it is a clean, efficient, and versatile energy source that can be produced from renewable sources. ChatGPT, Personal Communication, Apr. 24, 2023.

In practice, hydrogen gas is difficult to store compactly and efficiently because it has a very low density. This means that a large amount of space is needed to store even a small amount of hydrogen. Because hydrogen gas is a collection of small molecules, it can easily leak through minute gaps in storage containers, valves, or pipes. This can result in hydrogen loss, plus waste and potential danger.

To meet spatial constraints, hydrogen gas must often be stored at high pressures to achieve the required density for use in fuel cells or combustion engines. Such high pressures require storage containers to be heavier and are thus expensive to manufacture.

Another adverse consequence of hydrogen storage is embrittlement. It is known that hydrogen can cause embrittlement in metals, making it difficult to store hydrogen safely in metal containers for long periods of time. Id.

Against this backdrop, it would be desirable to have a system and method to make hydrogen gas on-demand, thereby minimizing or eliminating the need to store hydrogen between its production and use.

Particularly in third-world countries, access to electricity may be limited. In such environments, it would be desirable to make hydrogen using a system that is relatively compact and readily transportable. Such a system, in combination with suitable equipment, might generate electricity in remote locations.

To generate electricity using hydrogen for a fuel cell and a generator, steps such as these may be involved:
a. Produce hydrogen. Once produced, it would be beneficial to use the hydrogen gas on-demand without needing to store it in pressure vessels or pipelines for later use.
b. Convert the chemical energy of hydrogen into electrical energy in a fuel cell. One way to do this is to feed the hydrogen into the anode of the fuel cell, while oxygen is fed into the cathode. The chemical reaction between the two produces electricity that can be used to power an electric motor or to charge a battery.

The electricity produced by the fuel cell is direct current (DC). However, most electrical devices operate on alternating current (AC), so an inverter may be needed to convert the DC electricity into AC electricity.

If desired, a battery can store excess energy produced by the fuel cell. The stored energy can then be used when the demand for electricity exceeds the amount produced by the fuel cell. If the demand for electricity exceeds the capacity of the fuel cell and battery, a generator can be used to provide additional power. The generator can be powered by hydrogen or by another fuel source. Id. By using hydrogen to power a fuel cell and a generator, electricity can be generated cleanly and efficiently.

This process can be used in various applications, such as in stationary power generation for homes or businesses, or in transportation.

Of particular interest is green hydrogen. Green hydrogen is hydrogen gas that results from water being split into hydrogen and oxygen, conventionally by using electricity and electrolysis. The electricity used in the process may be generated by renewable sources such as wind, solar, or hydroelectric power.

The term “green” refers to the fact that the production of hydrogen in this way does not produce any greenhouse gas emissions. Greenhouse gases are said to negatively impact the environment when their concentrations in the atmosphere are excessive. Such gases trap heat from the sun, which causes the earth's temperature to increase. This is thought to lead to changes in climate patterns and sea level rise, more frequent and intense heat waves, droughts, floods, and extreme weather events.

This makes green hydrogen a promising alternative to traditional methods of producing hydrogen, which typically rely on fossil fuels and can contribute to climate change.

As noted earlier, conventional prior art hydrogen generation systems often require electrolysis. This is a low-efficiency process that consumes more energy than could be recuperated by fuel cells or internal combustion engines.

Prior art electrolysis involves the decomposition of water by passing a low-voltage current through the liquid water to produce hydrogen and oxygen, which can be burned in a combustion engine or fed into a fuel cell to generate energy. Conventional electrolysis systems require electrolytes (e.g., sulfuric acid) added to the water. Then an electrical current is passed through the water until enough energy is supplied to dissociate the hydrogen ions from the oxygen ions. Oxygen ions are attracted to the anode (+) and hydrogen ions are attracted to the cathode (−).

Prior art systems and methods for dissociating hydrogen from water molecules tend to be relatively inefficient and consume more energy than can be recaptured. Therefore, it would be desirable to have an improved hydrogen generation system that consumes less energy than conventional approaches to hydrogen generation. It is known that in some cases, supplementing electrolysis with a 10-MHz hybrid sound wave may have a beneficial effect on hydrogen production. See, e.g., newatlas.com/energy/hydrogen-sound-vibration-electrolysis, which is incorporated by reference. That approach used gold electrodes and an electrolyte with a neutral pH level contained in a glass electrolyte chamber. See also, 13 Advanced Energy Materials 7, Feb. 17, 2023—onlinelibrary.wiley.com/doi/10.1002/aenm.202203164, which is also incorporated by reference.

Against this background, it would be beneficial to provide clean energy on a commercially practical scale from an abundant fuel-water-without resorting to solar power or wind energy because the sun does not always shine and the wind does not always blow.

Among the patent references considered before filing this patent application are: EP2433902, EP3907181, PE20211530, US2012/0222954, US2017/0275160, and US2020/0376459.

### SUMMARY

Several aspects of this disclosure involve a system and method of making hydrogen from water. The method includes these steps.

A cylindrical reaction vessel is provided with an outer shell, a central shaft, and one or more concentric inner tubes separated by annular spaces. Water is delivered to the annular spaces under the influence of a pump through an inlet in communication with the central shaft. The water courses along a tortuous flow path. That path begins at an inner annular space around the central shaft and ends at an outer annular space beneath the outer shell. The water emerges from the reaction vessel through an outlet associated with a manifold positioned at an end of the reaction vessel.

A high-frequency vibratory stimulus is provided by a variable frequency drive or controller and is applied to the reaction vessel and water as it passes along the flow path. As a result, water molecules are dissociated into hydrogen molecules and oxygen atoms. These reaction products are delivered through an exit port in the reaction vessel along an effluent flow path to a receiving reservoir.

### BRIEF DESCRIPTION OF THE DRAWINGS

The disclosure and its advantages appear in greater detail in the context of the following description of embodiments given by way of illustration and with reference to the accompanying figures, in which:

FIG. 1 shows a representative arrangement of components that are electrically connected and comprise one embodiment of a system for making hydrogen according to the present disclosure.

FIG. 2 is a representative depiction of one liquid/gas hydraulic arrangement in the system;

FIG. 3 is a sectional view of concentric tubes and a central shaft housed within a reaction vessel.

### DETAILED DESCRIPTION

As required, detailed embodiments of the present invention are disclosed herein; however, it is understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Elements that are present in more than one of the figures are given the same references in each of them.

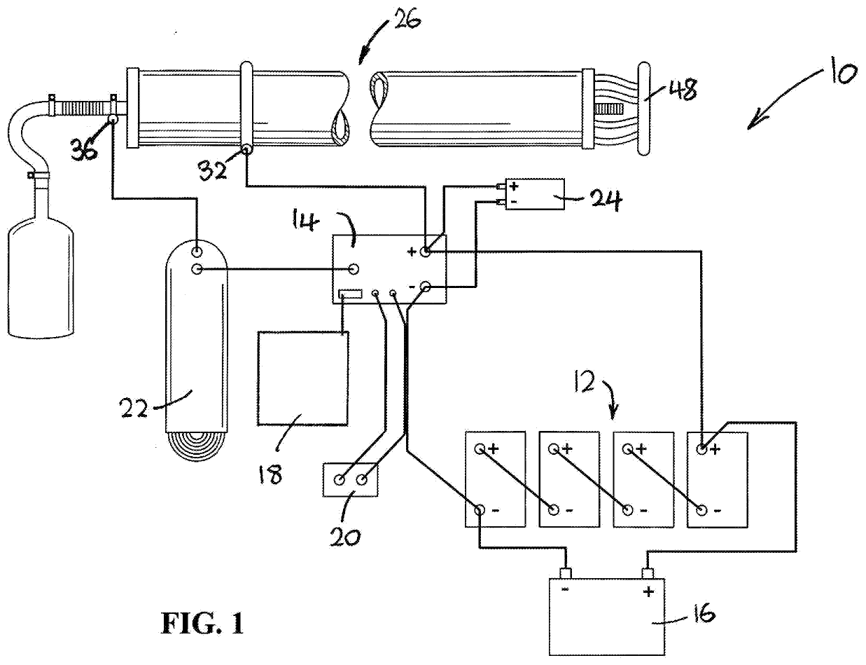

FIG. 1 shows a schematic diagram of a representative system (10) according to the disclosure. The main system components are depicted.

One or more batteries (12) provide a source of DC power to a variable frequency drive or controller (14). In one embodiment, there are four 12-volt batteries connected in series to provide 48 volts. If desired, a charger (16) may be coupled to one or more batteries. The batteries energize the variable frequency drive or controller. A preferred embodiment has an operating frequency of 18 kHz. One suitable variable frequency drive is a power amplifier that switches a power supply on and off rapidly, delivering power to a reaction vessel (26) in a series of pulses.

In combination with a computer or microprocessor, such as a personal computer, laptop, notebook, tablet, and the like (collectively, “microprocessor”) (18), a potentiometer (20) provides adjustments and a computer program adjusts a throttle device to influence desired outputs. For example, a throttle setting of 71% gave a 36-volt output, and 97% gave a 46-volt output. The latter setting yielded optimum hydrogen production. Lower percentages yielded less hydrogen production. The microprocessor is used to enter variables and values into the variable frequency drive (14) that controls the resulting vibration characteristics and displays the results.

If desired, an inductor (e.g., a high current 450-amp inductor from Coil Winding Specialist, Orange Grove, CA—www.coilws.com) (22), the potentiometer (e.g., B5k) (20), and a capacitor (e.g., 75 volt Cornell Dublilier 176719) (24) are connected to the variable frequency drive (14), as indicated in FIG. 1. The variable frequency drive communicates to the reaction vessel (26) a frequency (e.g., 18 kHz-18,000 cycles per second) that causes vibration in the reaction vessel (26) and its water contents. In some cases, harmonics are thereby created.

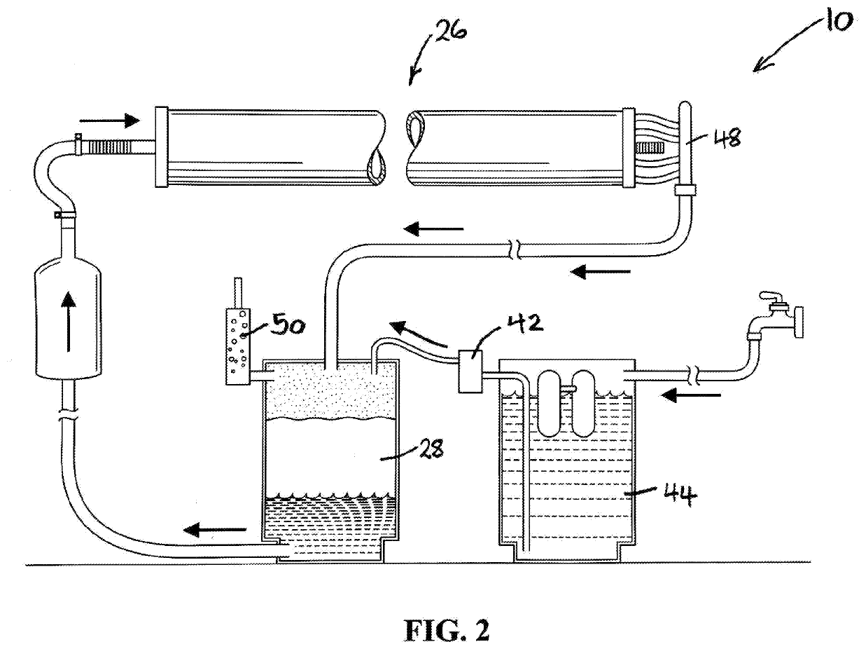

As shown in FIG. 2, a pressure vessel (28) receives influent water, which occupies about half of the pressure vessel's volume. Air and oxygen are held above the water. Hydrogen produced by the system lies above the air and oxygen. The pressure vessel (28) delivers effluent water to the reaction vessel (26), optionally through a water pump (e.g., 110 volt 1 HP sprinkler pump) (42).

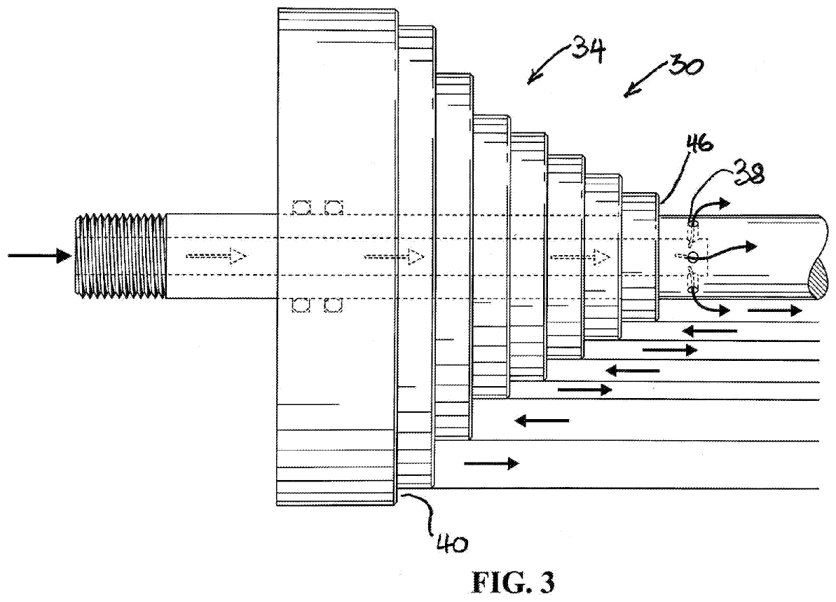

The reaction vessel (26) includes concentric tubes (30). A cross-section of the reaction vessel (26) and concentric tubes (30) appears in FIG. 3. Preferably the tubes (30) are made of stainless steel. In some embodiments, six tubes are deployed. An outer tube (32) has a relatively thick wall. Inner tubes (34) have thinner walls. A hollow central shaft (36) is provided. In some embodiments, the central shaft is also made of stainless steel. In the reaction vessel (26), water flows into the hollow central shaft (36), outwardly through orifices (38) provided along at least some of its length, and then along annular spaces (40) between the concentric tubes (30) via a tortuous path. The water partly re-circulates within the reaction vessel (26) by flowing back and forth about 3.5 times. Water flows from smaller (inner) tubes to larger (outer) tubes. The volumetric expansion of the gas/water mixture is thereby accommodated. If desired the reaction vessel (26) may be oriented horizontally as shown, or vertically if desired.

As noted earlier, a water pump (42) may lie between the pressure vessel (28) and the reaction vessel (26). Water plus impurities/catalyst(s) serve as an electrolytic medium. Preferably sodium hydroxide is added. Thus, impurities and ions in the water enable conduction.

If desired, influent water passes through a reverse osmosis unit (44) for cleansing before entry into the pressure vessel (28).

Baffles (46) are arranged between the concentric inner tubes (30). Consequently, a tortuous fluid flow path includes a first direction of flow along the inner annular space and an opposite direction of flow in the adjacent annular outer space, and so on until the outer shell is reached.

A liquid/gas effluent mixture from the reaction vessel (26) flows from a manifold (48) associated with the reaction vessel (26) to the pressure vessel (14) for interim storage before use.

Preferably, a direct current (e.g., 46-48 volts) runs from a positive battery terminal to a positive terminal of the variable frequency drive (14) to a positive terminal attached to the outer tube (32) of the reaction vessel (26). A direct current (e.g., 46-48 volts) runs from a negative battery terminal to a negative input terminal of the variable frequency drive (14). The negative output (M−) current (voltage varies based on throttle setting) runs from the variable frequency drive (14) to the central inner shaft (36) via an inductor (22), which stores at least some of the electrical energy.

As a result, the inner shaft (36) and concentric tubes (30) vibrate and subject the water to vibratory disturbance, which in some cases is a harmonic frequency.

Without being bound to a particular theory, when the water and tubes are forced into resonance vibrations at one of their natural frequencies, they vibrate in a manner such that a standing wave pattern is formed within the water. These patterns are only created at specific frequencies of vibration, termed “harmonic frequencies”, or merely harmonics. TPC Physics Tutorial: Fundamental Frequency and Harmonics (physicsclassroom.com).

In response, water molecules (H2O) within stainless steel electrodes (32, 36) are split into hydrogen molecules (H2) and oxygen atoms (O) by vibratory disturbance and electrolysis.

What results are clean end-products, including green hydrogen (50). If desired, a flow meter may be provided in communication with one or more gaseous effluents. Noteworthy is that in a desired environment of use, no hydrogen is stored long-term. This avoids the storage problems described above. Unless otherwise deployed, oxygen gas is allowed to escape to an ambient atmosphere.

Wastage is minimized because the water flowing from the reaction vessel (26) can be re-circulated.

Green hydrogen gas may be connected for example to a hydrogen motor that turns a generator to supply electricity or to a fuel cell generator. There are no adverse emissions.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

TABLE OF REFERENCE NUMERALS

| Reference No. | Component |
|---|---|
| 10 | System For Making Green Hydrogen |
| 12 | Batteries |
| 14 | Variable Frequency Drive |
| 16 | Charger |
| 18 | Microprocessor |
| 20 | Potentiometer |
| 22 | Inductor |
| 24 | Capacitor |
| 26 | Reaction Vessel |
| 28 | Pressure Vessel |
| 30 | Concentric Tubes |
| 32 | Outer Tube Electrode |
| 34 | Inner Tubes |
| 36 | Hollow Central Shaft Electrode |
| 38 | Orifices |
| 40 | Annular Spaces |
| 42 | Water Pump |
| 44 | Reverse Osmosis Unit |
| 46 | Baffles (non-conductive end cap) |
| 48 | Manifold |
| 50 | Hydrogen |

What is claimed is:

1. A method of making hydrogen from water, comprising:
providing a cylindrical reaction vessel with an outer shell, a central shaft, and one or more concentric inner tubes separated by annular spaces;
delivering water to the annular spaces through an inlet defined in the central shaft;
defining a tortuous flow path along which the water passes, the flow path beginning at an inner annular space around the central shaft and ending at an outer annular space beneath the outer shell, the water emerging from the reaction vessel through a manifold that lies in fluid communication with the annual spaces;
applying a high-frequency vibratory stimulus to the water as it passes along the flow path so that water molecules are dissociated into hydrogen molecules and oxygen atoms and delivered through an exit port in the manifold along an effluent flow path to a receiving pressure vessel.

2. The method of claim 1 wherein the cylindrical reaction vessel further includes baffles arranged between the concentric inner tubes so that the tortuous flow path includes a first direction of flow along the inner annular space and an opposite direction of flow in adjacent annular spaces.

3. The method of claim 1, wherein the high-frequency vibratory stimulus includes a resonant harmonic frequency.

4. A system for generating hydrogen, comprising:
a feed source of electrical energy;
a variable frequency drive in communication with the feed source to deliver an output that has a voltage between 36 volts and 48 volts and a frequency of about 18 kHz to the reaction vessel and water flowing therewithin; and
a microprocessor for programming the variable frequency drive.

5. The system of claim 4, further including a pressure vessel that receives influent water before delivery to the reaction vessel.

6. The system of claim 5, wherein the pressure vessel also holds air and hydrogen above the water.

7. The system of claim 4, further including a reaction vessel in communication with the variable frequency drive.

8. The system of claim 7, wherein the reaction vessel includes concentric tubes disposed around a central shaft.

9. The system of claim 8, wherein an outer tube has a wall thickness which exceeds that of inner tubes.

10. The system of claim 8, wherein the concentric tubes define an annular water flow path therebetween, the water flowing around and through the concentric tubes along annular flow paths before at least partially re-circulating within the reaction vessel, the water flowing from smaller inner tubes to larger outer tubes, thereby accommodating volumetric expansion of a gas/water mixture.

11. The system of claim 10, wherein the inner shaft and concentric tubes in the reaction vessel vibrate in response to signals from the variable frequency drive and subject the water to a vibratory disturbance.

12. The system of claim 10, further including a water pump that lies between a pressure vessel and the reaction vessel.

13. The system of claim 12, further including a reverse osmosis unit upstream of the pressure vessel for cleansing influent water.

14. The system of claim 4, wherein the variable frequency drive imparts a harmonic disturbance to the reaction vessel and flowing water, the harmonic disturbance creating a standing wave pattern that creates a reaction product of water molecules that are dissociated into oxygen and hydrogen.

15. The system of claim 14, wherein the reaction product flows through a manifold associated with the reaction vessel to the pressure vessel for interim storage before use.

16. The system of claim 14, wherein the reaction product includes green hydrogen.

17. The system of claim 16, further including a hydrogen motor that turns a generator to comprise a sub-assembly that supplies electricity with minimal adverse emissions.

18. The system of claim 17, wherein the sub-assembly is light in weight and can readily be transported.
